(19) United States
(12) Patent Application Publication
(10) Pub. No.: US 2018/0220841 A1
(43) Pub. Date: Aug. 9, 2018

(54) PRODUCT GROUPING AND SELECTION SYSTEM AND METHOD FOR FOOD HOLDING DEVICES

(71) Applicant: ENODIS CORPORATION, New Port Richey, FL (US)

(72) Inventors: Nicholas PATTERSON, Odessa, FL (US); Kenneth Lee LUNDBERG, Land O Lakes, FL (US); Ricardo ACOSTA, Land O Lakes, FL (US)

(21) Appl. No.: 15/890,743

(22) Filed: Feb. 7, 2018

Related U.S. Application Data
(60) Provisional application No. 62/456,200, filed on Feb. 8, 2017.

(51) Int. Cl. A47J 36/24; G06F 3/0488; A47J 39/00; H04W 4/35; G08B 21/18

(52) U.S. Cl. CPC A47J 36/2483; G06F 3/0488; G08B 21/18; H04W 4/35; A47J 39/006

(57) ABSTRACT

A system for storing food products at heated temperatures that includes a cabinet, a storage bin in the cabinet for receiving a tray, a temperature control device in thermal communication with the tray, and a controller displaying via a user interface a food product timer button that can be swiped to a side to change to a different food product timer button that is displayed on the user interface.

This application claims the benefit of U.S. Provisional Application No. 62/456,200, filed Feb. 8, 2017. The contents of U.S. Provisional Application No. 62/456,200, filed Feb. 8, 2017, are hereby incorporated by reference herein in their entirety

### BACKGROUND OF THE DISCLOSURE

### 1. Field of the Disclosure

The present disclosure relates to devices for holding food products at desired temperatures while they are waiting to be served to a customer. More particularly, the present disclosure relates to devices and associated methods utilized in a hot food holding cabinet to allow operators to easily select which food product from within a family of food products with common attributes is to be stored at the specified location.

### 2. Description of the Related Art

Hot holding cabinets are used in restaurants to store a plurality of cooked food products when the cook time for a product is longer than the customer expectation for wait time. This allows the restaurant to prepare food ahead of time to meet the customer's expectation of receiving a food product immediately or shortly after ordering. These holding cabinets have storage slots for food product trays, a heat source to keep the food product and their trays at a desired serving temperature, and a product tracking system to perform specific functions such as time tracking, product type identification, product status indications, process indications, audible feedback and alarm generation and display. Cabinets are supplied with prepared food products from a cooking device (e.g., a grill) and are generally capable of holding between 1 to 20 individual trays.

On these holding cabinets' control systems it is common that each food product holding location is programmed to accept a single product at any point in the day. This does not provide any level of flexibility to the user. Changing what product is to be stored and timed at a given location in the holding cabinet is generally a complex change involving, at a minimum, several button presses to move into a settings or menu configuration screen and can be even more complicated and cumbersome requiring computer based applications for changing food product locations which generally require saving and uploading the new menu files back into the hot food holding cabinets. There are some central based systems that send out menu information to many holding cabinets, however, they are generally equally as complicated to change.

Accordingly, there is a need to address these disadvantages of currently available systems.

### SUMMARY OF THE DISCLOSURE

A system for storing food products at heated temperatures is provided that includes a cabinet, a storage bin in the cabinet for receiving a tray, a temperature control device in thermal communication with the tray, and a controller displaying via a user interface a food product timer button that can be swiped to a side to change to a different food product timer button that is displayed on the user interface.

The system for storing food products at heated temperatures also can provide a controller that has criteria so that only similar products can be grouped in the predetermined grouping.

### BRIEF DESCRIPTION OF THE DRAWINGS

FIG. 1A is a top, front perspective view of a cabinet having a system and method of product grouping and selection of the present disclosure.

FIG. 1B is a top, front perspective view of an alternative cabinet having the system and method of product grouping and selection of the present disclosure.

FIG. 2 is a side, perspective view of the cabinet of FIG. 1 having a portion removed and trays positioned therein.

FIGS. 3A and 3B are side view of trays that are used in the cabinet of FIGS. 1A, 1B and 2.

FIG. 4 is a schematic drawing of the cabinet of FIGS. 1A, 1B and 2.

FIGS. 5-7 are screenshots of an interface of the cabinets of FIGS. 1A, 1B and 2 illustrating a first-in-first-out feature of the system and method of product grouping and selection.

FIGS. 8-12 are screenshots of the interface of the cabinets of FIGS. 1A, 1B and 2 illustrating a group select feature of the system and method of product grouping and selection.

FIG. 13 is a flow chart showing process steps of a controller of the system and method of product grouping and selection.

### DETAILED DESCRIPTION OF THE DISCLOSURE

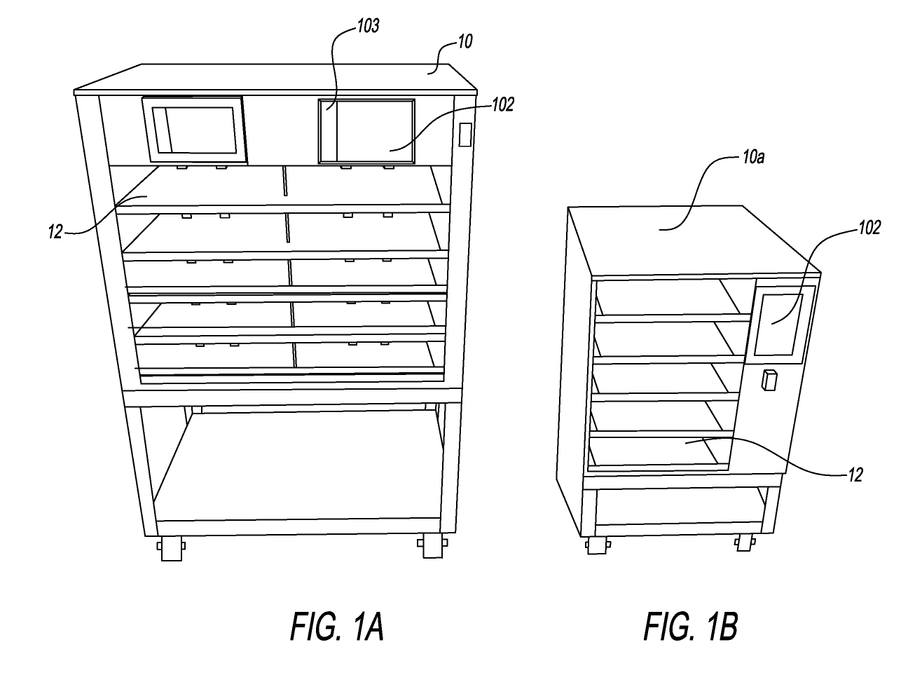

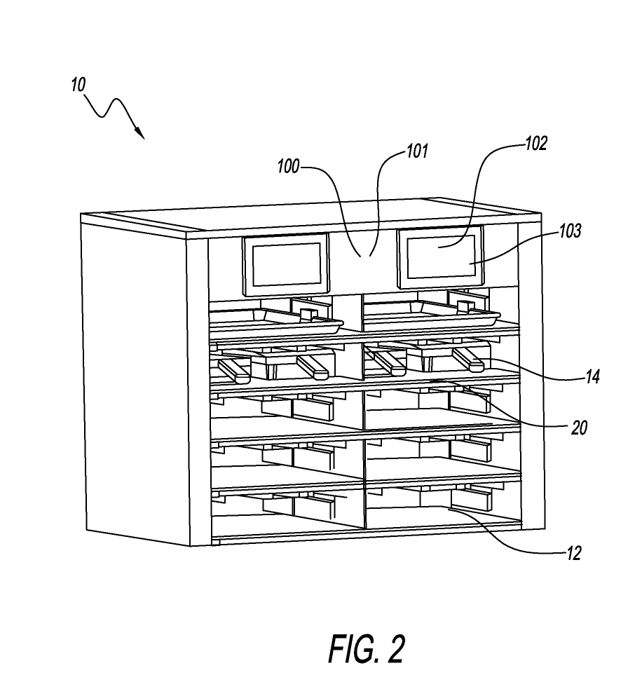

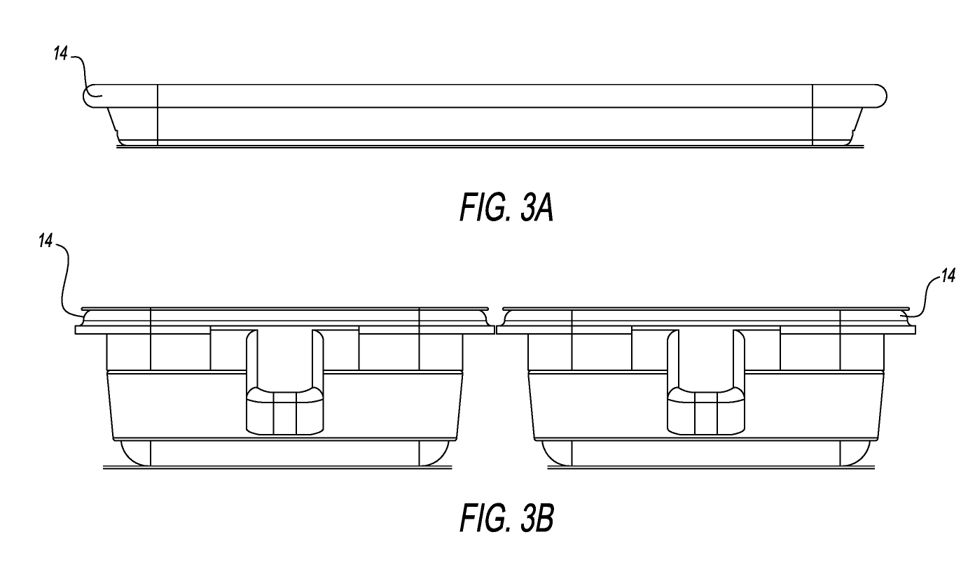

Referring to FIGS. 1A, 2, 3A and 3B, and in particular FIG. 2, cabinet 10 of the present disclosure is shown. Cabinet 10 has a plurality of tray storage bins 12. Each of tray bins 12 can receive one or more of trays 14, the latter of which holds one or more food products (not shown). As shown in FIGS. 3A and 3B, trays 14 can either have a shallow profile with relatively long sides (FIG. 3A), or be deep with shorter sides (FIG. 3B). The suitable type of tray 14 will depend on the food product to be stored therein.

In the shown embodiment, cabinet 10 is a cabinet with ten bins 12, in a five row by two wide arrangement where the two wide refers to a specific industry standard pan. Each bin 12 can have space for one or two trays 14. In the embodiment shown in FIG. 1A, for example, top bins 12 each receive a larger tray 14, but the bins lower down each store a narrower tray 14. The present disclosure contemplates cabinets with anywhere from one bin 12, to one or more bins. In one embodiment there are up to and equal to twenty bins 12. In any of these embodiments, bins 12 could fit multiple trays 14. The cabinets may be sized to fit different needs in different areas of the restaurant. For example, in a service area near the front of the establishment, a smaller cabinet with, for example, four bins 12 may be appropriate. In the rear of the establishment, it may be suitable to have a larger cabinet with up to 20 bins. FIG. 1B shows an alternative cabinet 10a that is the same as cabinet 10 except smaller in size than cabinet 10, and, accordingly, the same references numerals are used for the same features.

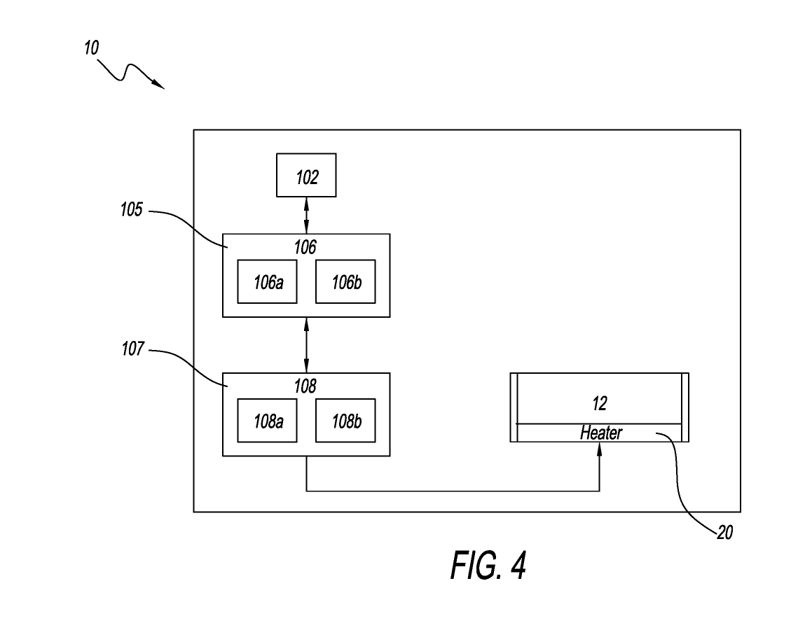

Referring back to FIG. 2, each bin 12 has a temperature control device such as a heater 20 associated therewith. Heaters 20 can be a number of suitable devices for providing heat to bin 12 and tray 14. Heaters 20 can be inductive, conductive (e.g., heated plates), convective (e.g., hot air flow), radiant (e.g. heat lamps, calorimeter rods), and any combination thereof. The heaters 20 are regulated by either a temperature sensor or a software algorithm, both linked to a processor 108a (FIG. 4) to achieve desired temperature, as described above. Although the present disclosure is primarily directed to keeping trays 14 at elevated temperatures within bins 12, the devices and methods of the present disclosure could be used to keep trays 14 at ambient temperatures, or to cool them as well. In addition, the term “bin” is used for simplicity, to describe a fully- or semi-enclosed location or zone capable of storing and holding one or more trays.

Cabinet has a user interface 102. User interface 102 is a touch screen as is known in the art. One example of a touch screen that is used for user interface 102 is a glass-front projected capacitive touch screen display, for example, manufactured by ThreeFive Corp.

Referring to FIG. 4, user interface 102 is in communication with an interface controller 105 that has one or more user interface boards 106. User interface board 106 has a processor 106a and a memory 106b. The x-y coordinates of a touch, for example, by a finger of a user, are sensed using projected capacitive technology on an interface surface 103, for example, a glass surface, of the touch screen of user interface 102. If the touch is removed, then the touch is sensed by the touch screen of user interface 102 as a tap or, in other words, was simply a press. If x-y coordinates of the touch begin to move, a swipe is detected by the touch screen of user interface 102 and a direction can be sensed by the touch screen of user interface 102. The detection of the x-y coordinates of the touch sensed by the touch screen of user interface 102 are sent to interface processor 106a in real time.

Heater 20 is in electrical communication with a temperature control controller 107. Temperature control controller 107 has a temperature control board 108. Temperature control board 108 has a temperature control processor 108a and temperature control memory 108b. Temperature control controller 107 control the state (on/off) and optionally the amount of power supplied to heater 20 as needed, to keep any food products in tray 14 warm. Temperature control processor 108a monitors and controls the temperature of individual bins 12 with heaters 20. Temperature set points can be sent from interface processor 106a, and additional heater on-time or reduced power or reduced heater on-time can be supplied to heaters 20 as needed. Optionally, the temperature values of heated surfaces 20 can be reported from temperature control processor 108a back to interface processor 106a. Temperature could also be managed by a simple algorithm, which adjusts the percentage of time the heater is powered on and off relative to what temperature setting is set in the control. Thus, in this embodiment, interface processor 106a can be an aggregator of the data collected by the other processors including temperature control processor 108a. Interface controller 105, temperature control controller 107, and heater 20 are all in electrical communication with one another.

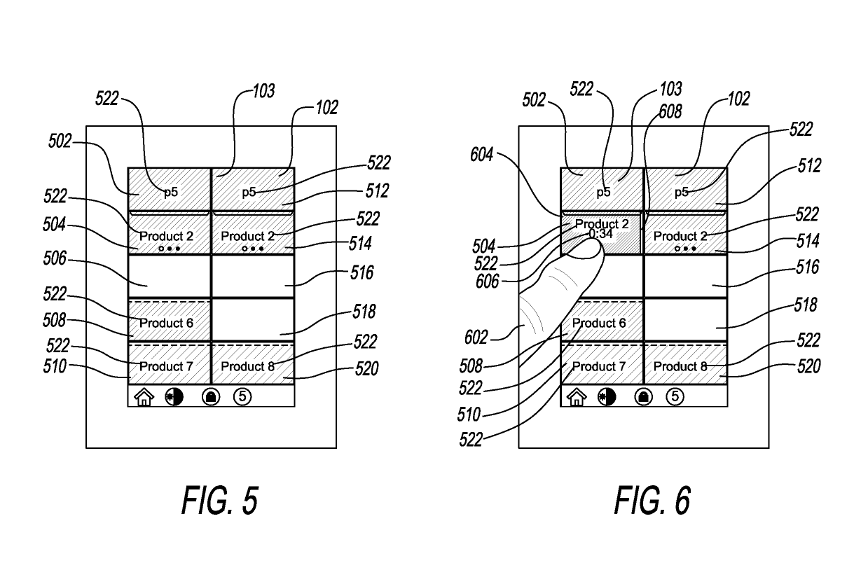

Referring to FIG. 5, user interface 102 displays on the touchscreen a screen divided into a x by y matrix of discrete sections 502, 504, 506, 508, 510, 512, 514, 516, 518, 520. The touchscreen has ten sections such that each of sections 502, 504, 506, 508, 510, 512, 514, 516, 518, 520 displays information related to one of the ten tray bins 12. The x by y matrix of sections 502, 504, 508, 510, 512, 514, 520 is shown as having a matrix of 5 rows by 2 columns; however, the matrix could have a greater or less number sections and of a greater or less number rows or columns for different sized cabinets. Sections 502, 504, 508, 510, 512, 514, 520 each display a product identifier 522. Product identifier is, for example, a product name, abbreviation, other identifying symbol, or combination thereof. Each of sections 502, 504, 508, 510, 512, 514, 520 have an indicator, for example a light grey color, indicating a ready state in which a timer has not been activated. Sections 502, 504, 508, 510, 512, 514, 520 in the ready state can be selected by a tap, for example, a finger of a user contacts surface 103 within one of sections 502, 504, 508, 510, 512, 514, 520. The detection of the x-y coordinates of the touch sensed by the touch screen of user interface 102 by the tap are sent to interface processor 106a that determines the location of the tap, for example, within one of sections 502, 504, 506, 508, 510, 512, 514, 516, 518, 520. The tiled screen can be one screen option, for example, home screen.

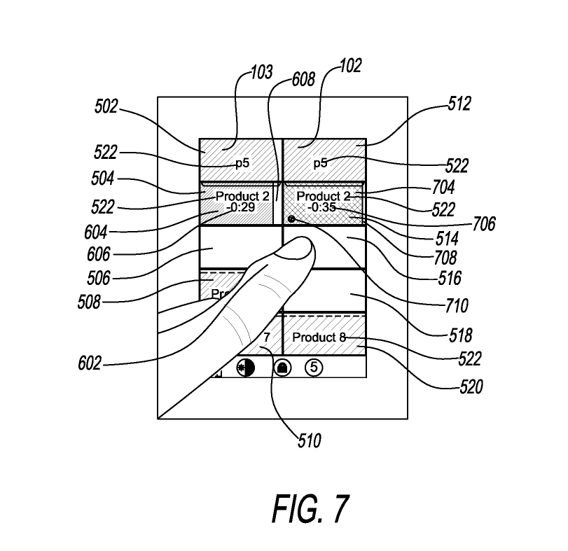

Referring to FIG. 6, after a finger 602 of a user tapped surface 103 within section 504, user interface 102 displays a first indicator 604, for example, a change of the color of section 504 such as a green color, on the touchscreen that indicates section 504 has been selected by the tap of finger 602 and user interface 102 displays numbers of a first timer 606 on the touchscreen in section 504. First indicator 604 indicates a time of first timer 606, for example, by the color of first indicator 604 changing to a color 608 from right to left with the time of first timer 606. First indicator 604 indicates the time of first timer 606 in FIG. 7 is less than the time of first timer 606 shown in FIG. 6 by the second color 608 covering a greater area of section 504 in FIG. 7 than the area covered by second color 608 show in FIG. 6. Sections 502, 504, 506, 508, 510, 512, 514, 516, 518, 520 form a tiled screen of timers.

Referring to FIG. 7, after finger 602 of the user tapped surface 103 within section 514 that has the same product identifier 522, namely, “Product 2”, as section 504, user interface 102 displays a second indicator 704, for example, a change of the color of section 514 such as a dark grey color, on the touchscreen that indicates section 514 has been selected by the tap of finger 602 and user interface 102 displays numbers of a second timer 706 on the touchscreen in section 514. Second indicator 704 indicates a time of second timer 706, for example, by the color of second indicator 704 changing to a color 708 from right-to-left with the time of second timer 706. Section 504 has the timer that was activated first, and, thus, displays first indicator 604. If first timer 606 is canceled, then first indicator 604 is displayed in section 514 since section 514 has second timer 706 that was activated second after first timer 606 and displays the same product identifier 522. Users of cabinet 10 can be trained to use the food in tray 14 corresponding to sections 502, 504, 506, 508, 510, 512, 514, 516, 518, 520 displaying first indicator 604 before other trays holding the same food that do not have first indicator 604. Each of sections 502, 504, 506, 508, 510, 512, 514, 516, 518, 520 that displays the first activated, or, in other words, oldest, timer for each different product identifier 522 will display first indicator 604. In addition, the touchscreen can communicate additional information, for example, by icon 710.

To cancel first timer 606, section 504 is tapped again so that a reset screen is displayed in section 504. If finger 602 taps a reset icon, first timer 606 is stopped and product identifier 522 is displayed with the grey/ready state indicator in section 504. It is determined if another timer of the same product identifier is still active, that will then display that timer with first indicator 604 as the First Out state. If finger 602 taps a cancel icon, first timer 606 continues counting for the product identifier 522 selected with first indicator 604 displayed in section 504.

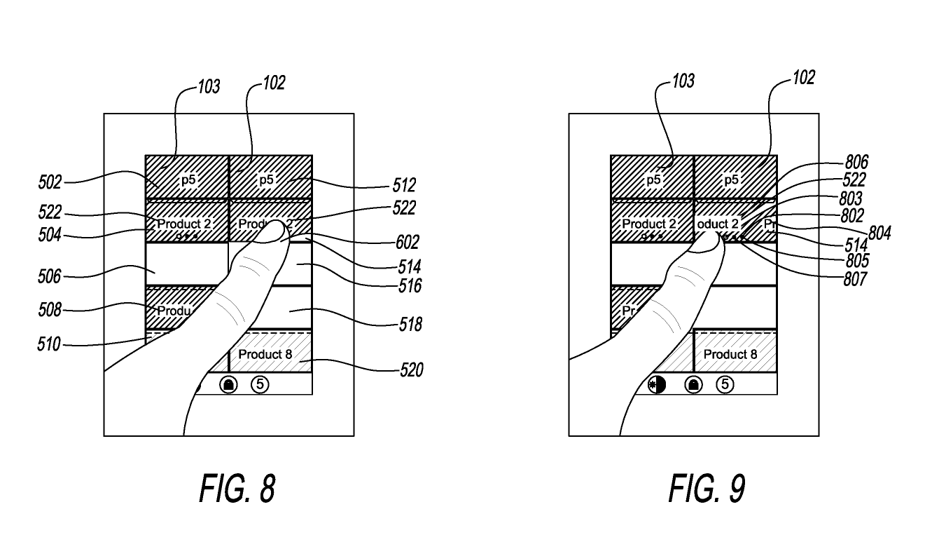

Referring to FIGS. 8 and 9, section 514 shows a section screen indicator 802. Section screen indicator 802 indicates that there is a group of products that can be selected from and each displayed in section 514. Section screen indicator 802 has three dots showing a first dot 803 as a different color than a second dot 805 and a third dot 807. The three dots of section screen indicator 802 indicates that there are three product identifiers available for display on section 514. First dot 803 having a different color than second dot 805 and third dot 807 indicates that product identifier 522 is a first product identifier 806 being displayed in section 514. As shown in FIG. 9, finger 602 contacts surface 103 in section 514 and moves finger 602 left while maintaining contact with surface 103 for swiping movement in section 514 to display a second product identifier 804 to be shown in section 514. Finger 602 contacting surface 103 in section 514 and moving finger 602 right while maintaining contact with surface 103 for swiping movement in section 514 would display a third product identifier 1102 (FIG. 11) in section 514. The detection of the x-y coordinates of the touch sensed by the touch screen of user interface 102 are sent to interface processor 106a that determines the location and the swiping movement of finger 602.

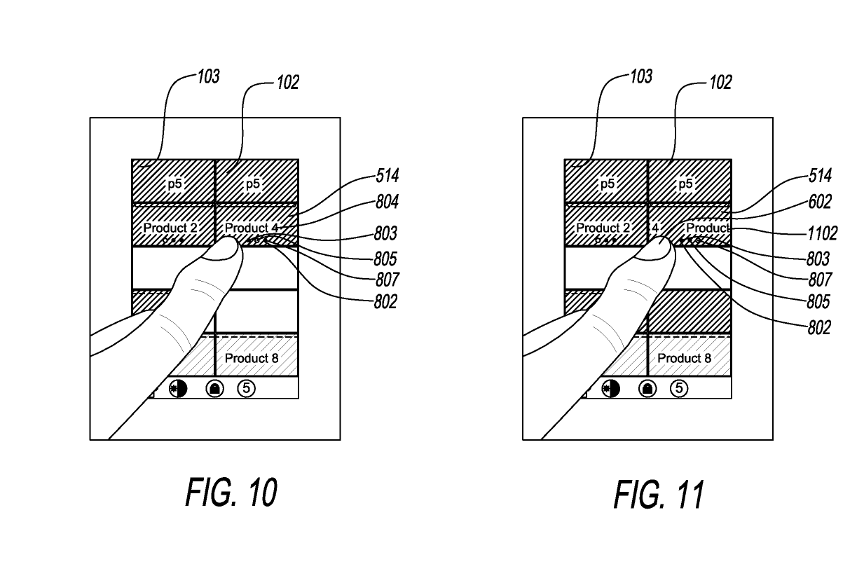

Referring to FIG. 10, second product identifier 804 is shown as “Product 4” in section 514. Section screen indicator 802 shows second dot 805 as a different color than first dot 803 and third dot 807. Second dot 805 having a different color than first dot 803 and third dot 807 indicates that second product identifier 804 is a second of three product identifiers being displayed in section 514. Finger 602 contacting surface 103 in section 514 and moving finger 602 right while maintaining contact with surface 103 for swiping movement in section 514 would again display product identifier 522, namely, first product identifier 806, in section 514.

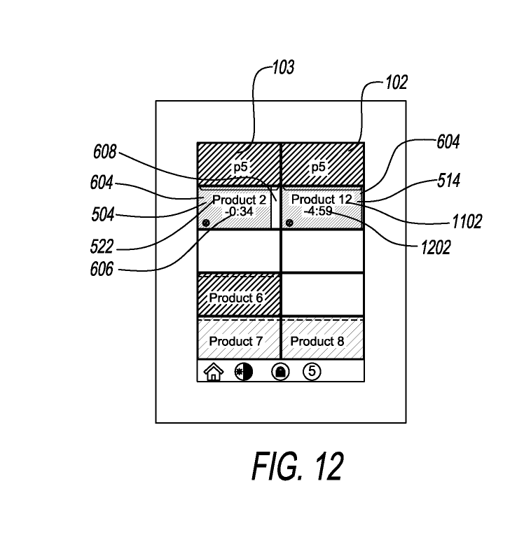

Referring to FIGS. 11 and 12, repeating the swiping movement by moving finger 602 left while maintaining contact with surface 103 in section 514 displays third product identifier 1102 shown as “Product 12”. Section screen indicator 802 shows third dot 807 as a different color than first dot 803 and second dot 805. Third dot 807 having a different color than first dot 803 and second dot 805 indicates that third product identifier 1102 is a third of three product identifiers being displayed in section 514. Finger 602 contacting surface 103 in section 514 and moving finger 602 right while maintaining contact with surface 103 for swiping movement in section 514 would again display second product identifier 804 in section 514. Finger 602 contacting surface 103 in section 514 and moving finger 602 left while maintaining contact with surface 103 for swiping movement in section 514 would again display product identifier 522, namely, first product identifier 806, in section 514.

Referring to FIG. 12, section 504 has been selected by the tap of finger 602 and user interface 102 displays numbers of first timer 606 on the touchscreen in section 504. Section 514 has also been selected by a tap of finger 602 and user interface 102 displays numbers of a timer 1202 on the touchscreen in section 504. Timer 1202 can have a different period of time for each first product identifier 806, second product identifier 804 and third product identifier 1102. For example, timer 1202 can count a 40 second time period for first product identifier 806, timer 1202 can count a 2 minute time period for second product identifier 804, and timer 1202 can count a 5 minute time period for third product identifier 1102. When timer 1202 completes counting of the time period, then an alert is displayed, which can be different for each of first product identifier 806, second product identifier 804 and third product identifier 1102. For example, timer 1202 completes counting for first product identifier 806 a three beep alarm is activated and section 514 is displayed having a red background, timer 1202 completes counting for second product identifier 804 a five beep alarm is activated and section 514 is displayed having a red background, and timer 1202 completes counting for third product identifier 1102 a one beep alarm is activated and section 514 is displayed having a red background.

Referring to FIG. 12, section 504 has the only activated timer, first timer 606, activated for product identifier 522 of “Product 2” making first timer 606 the oldest timer for “Product 2”, and, thus, section 504 displays first indicator 604. Section 514 has the only activated timer, timer 1202, activated for third product identifier 1102 of “Product 12” making timer 1202 the oldest timer for “Product 12”, and, thus, section 514 also displays first indicator 604. When a timer, for example, timer 1202, is actively counting down, another product identifier cannot be displayed, in other words, finger 602 contacting surface 103 in section 514 and moving finger 602 left or right while maintaining contact with surface 103 for swiping movement in section 514 would not change the display of product identifier 522 in section 514 when timer 1202 is actively counting down. Only when the timer is in an idle state, or no timer has been activated, do dots, for example, screen indicator 802, are displayed to allow for swipe select, or swiping to change product identifier 522 displayed in section 514.

Accordingly, a swiping touch of finger 602 can change product identifier 522 displayed in section 514 according to a predetermined order of a predetermined grouping with criteria that allows only similar products to be grouped in the predetermined grouping. Similar products, for example, are products that are held at the same temperature, in the same width tray, and with the same lid type if needed. Accordingly, user interface 102 displays each product identifier 522 of a plurality of products defined in the predetermined grouping to be held in one bin 12 so that product identifier 522 of each of the plurality of products to be held in the bin 12 is selectable via user interface 102 in one of a corresponding sections 502, 504, 506, 508, 510, 512, 514, 516, 518, 520.

User interface 102 displays on the touchscreen a screen divided into a x by y matrix of discrete sections 502, 504, 506, 508, 510, 512, 514, 516, 518, 520. Each of sections 502, 504, 506, 508, 510, 512, 514, 516, 518, 520 can be set up to manage one individual food product, for example, section “Product 6” could instead read “Bacon” for section 508, or a section, for example, section 514 can represent a group of similar products such as “Breakfast Meats” including first product identifier 806 where “Product 2” could instead read “Bacon”, second product identifier 804 where “Product 4” could instead read “Sausage”, and third product identifier 1102 where “Product 12” could instead read “Ham”. Additionally, another product identifier could be included such as “Canadian Bacon”. In general use, when the timer, for example, timer 1202, is pressed, timer 1202 begins to count down to expiration or “0:00”. However, in the case that a group of products is being used the user can swipe or arrow left or right to select from the multiple products in the group, for example, first product identifier 806, second product identifier 804, third product identifier 1102. This gives obvious, simple, intuitive flexibility to the user who can now select any product from the “Breakfast Meats” group without having to do any reprogramming. As a different item is selected, the timing, alarm, and other options for the said location will change. For instance, finger 602 tapping first product identifier 806 for “Bacon” activates timer 1202 for 30 minutes with 5 minute cook more alarm and a three beep expired alarm but finger 602 tapping second product identifier 804 for “Sausage” activates timer 1202 for 60 minutes with 10 minute cook more alarm and a 5 beep expired alarm. By swiping or arrow selecting the different products identifiers 522 within the same one of sections 502, 504, 506, 508, 510, 512, 514, 516, 518, 520, cabinet 10 can be flexible to multiple hold times, cook more times, alarm types. Cook more times allow the user to input, for example, tap the touchscreen when prompted, to extend a timer for a predetermined period of time, namely, cook more time. Selecting the different products identifiers 522 may alternatively communicate from interface controller 105 to temperature control controller 107 to increase or decrease temperature of heater 20. Accordingly, a selection of each of different product identifiers 522 within the same one of sections 502, 504, 506, 508, 510, 512, 514, 516, 518, 520, controls user interface 102 according to predetermined operations associated with the selected of product identifiers 522, for example, a type of alarm, a time period for timer 606, 706, 1202, a temperature to be communicated to temperature control controller 107, and any combination thereof.

The significant advantage of the present disclosure allows the user to select from multiple menu items, easily, within one second, without having to reprogram anything in cabinet 10. This functionality is a key advantage with customers who demand flexibility in what food products are held in their cabinet on a day-to-day basis. As an example, a store may be selling an unexpectedly high volume of sausage patties and very few bacon items. One of the bacon holding locations could easily be changed to sausage without having to do any reprogramming. This solution allows for multiple products, having similar holding attributes such as holding temperature and lid type to be grouped and selected with ease, without the need to reprogram cabinet 10. This is also a significant advantage when restaurants are changing over between different menus, such as from breakfast to lunch. As an example, a group could contain both hash browns (breakfast) and French fries (lunch) and the user would not need to change the configuration on cabinet 10.

A key process to the present disclosure is to be able to select from a plurality of food items in one of sections 502, 504, 506, 508, 510, 512, 514, 516, 518, 520 without having to do any reprogramming of interface controller 105. While we envision this in its easiest form as a swipe left or right on a touchscreen, alternative options could include left and right, or up and down arrows for the selected bin 12 where a press-and-hold method could be used. For instance, press and hold a button for a few seconds, then use the up or down arrow to select from different products.

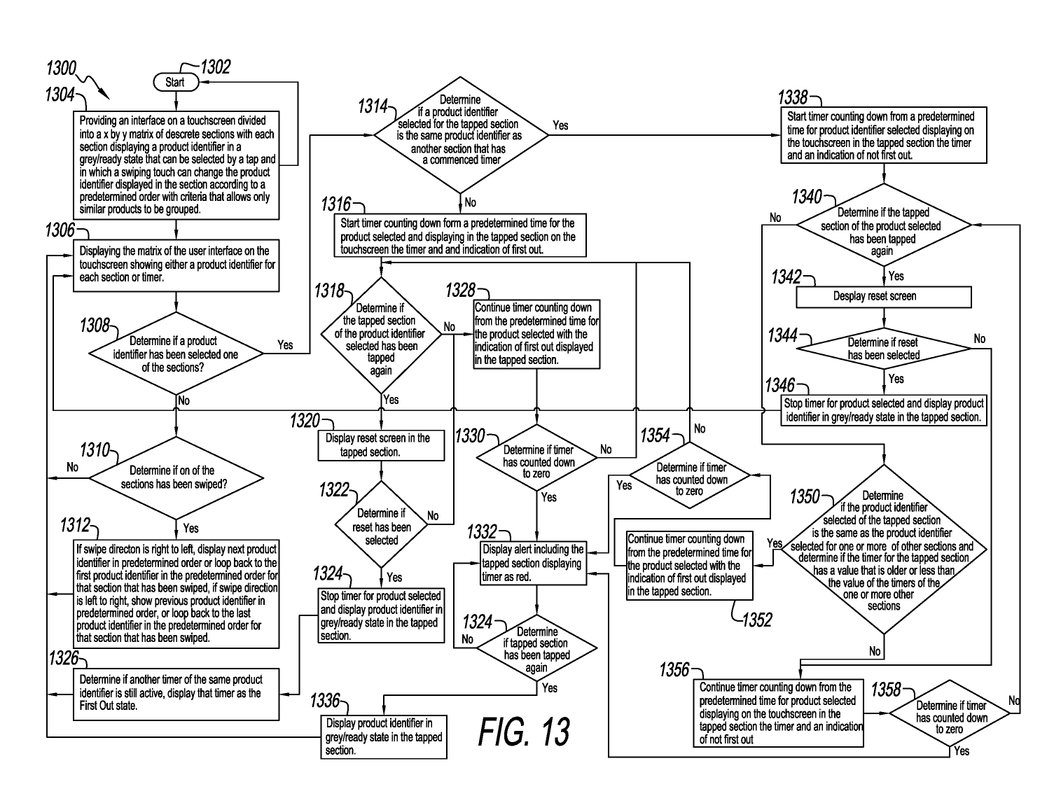

Referring to FIG. 13, a method 1300 that can be used with cabinet 10 is shown. Method 1300 begins at step 1302 and proceeds to step 1304. In step 1304, an interface, user interface 102, is provided on a touchscreen divided into a x by y matrix of discrete sections, sections 502, 504, 506, 508, 510, 512, 514, 516, 518, 520, with each section displaying a product identifier, product identifier 522, in a grey/ready state that can be selected by a tap and in which a swiping touch can change the product identifier displayed in the section according to a predetermined order with criteria that allows only similar products to be grouped.

Method 1300 proceeds from step 1304 to step 1306. In step 1306, the matrix of the user interface is displayed on the touchscreen showing a product identifier, for example, product name, like “Bacon”, abbreviation of a product name like “BACN” to identify bacon, a picture of a bacon strip, or even and icon that looks like a cartoon piece of bacon, for each section or timer, for example, first timer 606. Method 1300 proceeds from step 1306 to step 1308. In step 1308, it is determined if a product identifier has been selected by tapping one of the sections. If no product identifier has been selected, method 1300 proceeds from step 1308 to step 1310. In step 1310, it is determined if one of the sections has been swiped. If one of the sections has not been swiped, method 1300 returns to step 1306. If one of the sections has been swiped, method 1300 proceeds from step 1310 to step 1312. In step 1312, if swipe direction is right to left, display next product identifier in predetermined order or loop back to the first product identifier in the predetermined order for that section that has been swiped, if swipe direction is left to right, show previous product identifier in predetermined order, or loop back to the last product identifier in the predetermined order for that section that has been swiped. After step 1312, method 1300 returns to step 1306.

If a product identifier has been selected, method 1300 proceeds from step 1308 to step 1314. In step 1314, it is determined if the product identifier selected for the tapped section is the same product identifier as another section that has a commenced timer. If another section does not have a commenced timer, method 1300 proceeds from step 1314 to step 1316. In step 1316, a timer, first timer 606, starts counting down from a predetermined time for the product selected and displaying in the tapped section on the touchscreen the timer and an indication of first out, first indicator 604. Method 1300 proceeds from step 1316 to step 1318.

In step 1318, it is determined if the tapped section of the product identifier selected has been tapped again. If the tapped section has been tapped again, method 1300 proceeds from step 1318 to step 1320. In step 1320, a reset screen is displayed in the tapped section. Method 1300 proceeds from step 1320 to step 1322. In step 1322, it is determined if reset has been selected. If reset has been selected, method 1300 proceeds from step 1322 to step 1324. In step 1324, the timer is stopped for the product selected and the product identifier is displayed in grey/ready state in the tapped section. Method 1300 proceeds from step 1324 to step 1326. In step 1326, it is determined if another timer of the same product identifier is still active, that will then display that timer as the First Out state. Method 1300 proceeds from step 1326 to repeat step 1306. In step 1322, if reset has not been selected, method 1300 proceeds from step 1322 to step 1328. In step 1328, the timer continues counting down from the predetermined time for the product identifier selected with the indication of first out displayed in the tapped section.

In step 1318, if the tapped section has not been tapped again, method 1300 proceeds from step 1318 to step 1328. In step 1328, the timer continues counting down from the predetermined time for the product identifier selected with the indication of first out displayed in the tapped section. Method 1300 proceeds from step 1328 to step 1330, it is determined if timer has counted down to zero. If timer has not counted down to zero, method 1300 proceeds to repeat step 1318. If timer has counted down to zero, method 1300 proceeds to from 1330 to step 1332. In step 1332, an alert is displayed including the tapped section displaying timer as red. Method 1300 proceeds to from 1332 to step 1334. In step 1334, it is determined if tapped section has been tapped again. If tapped section has not been tapped again, method 1300 proceeds to from 1334 to repeat step 1332. If tapped section has been tapped again, method 1300 proceeds to from 1334 to step 1336. In step 1336, product identifier is displayed in grey/ready state in the tapped section. Method 1300 proceeds to from 1336 to repeat step 1306.

In step 1314, if another section does have a commenced timer, method 1300 proceeds from step 1314 to step 1338. In step 1338, timer, second timer 706, is started counting down from a predetermined time for product identifier selected displaying on the touchscreen in the tapped section, section 514, the timer and an indication of not first out, second indicator 704. Method 1300 proceeds from step 1338 to step 1340. In step 1340, it is determined if the tapped section of the product selected has been tapped again. If the tapped section has been tapped again, method 1300 proceeds from step 1340 to step 1342. In step 1342, a reset screen is displayed in the tapped section. Method 1300 proceeds from step 1342 to step 1344. In step 1344, it is determined if reset has been selected. If reset has been selected, method 1300 proceeds from step 1344 to step 1346. In step 1346, the timer is stopped for the product selected and the product identifier is displayed in grey/ready state in the tapped section. Method 1300 proceeds from step 1346 to repeat step 1306.

If the tapped section has not been tapped again in step 1340, method 1300 proceeds from step 1340 to step 1350. In step 1350, it is determined if the product identifier selected of the tapped section is the same as the product identifier selected for one or more of other sections and determine if the timer for the tapped section has a value that is, older, or less than, the value of the timers of the one or more other sections. If the product identifier selected of the tapped section is the same as the product identifier selected for one or more of other sections and if the value is older, method 1300 proceeds from step 1350 to step 1352. In step 1352, timer continues to counting down from the predetermined time for product selected changing the indication to first out displayed in the tapped section. Method 1300 proceeds from step 1352 to step 1354. In step 1354, it is determined if timer has counted down to zero. If timer has not counted down to zero, method 1300 proceeds from step 1354 to repeat to step 1318. If timer has counted down to zero, method 1300 proceeds from 1354 to repeat step 1332.

In step 1350, if the product identifier selected of the tapped section is not the same as the product identifier selected for one or more of other sections or if the value is not older, method 1300 proceeds from step 1350 to step 1356. In step 1356, the timer counting down from the predetermined time for product selected is continued displaying on the touchscreen in the tapped section the timer and an indication of not first out. Method 1300 proceeds from step 1356 to step 1358. If timer has not counted down to zero, method 1300 proceeds from step 1358 to repeat to step 1340. If timer has counted down to zero, method 1300 proceeds from 1358 to repeat step 1332.

If reset has not been selected in step 1344, method 1300 proceeds from step 1344 to step 1356.

Method 1300 continues while user interface 102 is being operated.

FIG. 4 shows a block diagram of interface controller 105, for implementation of the present system and method.

Interface controller 105 includes user interface 102, processor 106a and memory 106b. Interface controller 105 may be implemented on a general-purpose microcomputer. User interface 102 will generally include a keyboard or a touch screen for entering user input.

Although interface controller 105 is represented herein as a standalone device, it is not limited to such, but instead can be coupled to other devices (not shown) via a network, for example, the internet.

Processor 106a is configured of logic circuitry that responds to and executes instructions.

Memory 106b stores data and instructions for controlling the operation of processor 106a to perform the functions, generate the displays and provide the display features discussed above. Memory 106b may be implemented in a random access memory (RAM), a hard drive, a read only memory (ROM), or a combination thereof. One of the components of memory 106b is a program module.

The program module contains instructions for controlling processor 106a to execute the methods described herein, for example, method 1300.

The term “module” is used herein to denote a functional operation that may be embodied either as a stand-alone component or as an integrated configuration of a plurality of sub-ordinate components. Thus, the program module may be implemented as a single module or as a plurality of modules that operate in cooperation with one another. Moreover, although the program module is described herein as being installed in memory 106b, and therefore being implemented in software, it could be implemented in any of hardware (e.g., electronic circuitry), firmware, software, or a combination thereof.

User interface 102 includes an input device, such as the touchscreen, a keyboard or speech recognition subsystem, for enabling a user to communicate information and command selections to processor 106a. User interface 102 also includes an output device such as a display or a printer. A cursor control such as the touchscreen, a mouse, track-ball, or joy stick, allows the user to manipulate a cursor on the display for communicating additional information and command selections to processor 106a.

Processor 106a outputs, to user interface 102, a result of an execution of the methods described herein. Alternatively, processor 106a could direct the output to a remote device (not shown) via network.

While the program module is indicated as already loaded into memory 106b, it may be configured on a storage medium for subsequent loading into memory 106b. The storage medium can be any conventional storage medium that stores the program module thereon in tangible form. Examples of the storage medium include a floppy disk, a compact disk, a magnetic tape, a read only memory, an optical storage media, universal serial bus (USB) flash drive, a digital versatile disc, or a zip drive. Alternatively, the storage medium can be a random access memory, or other type of electronic storage, located on a remote storage system and coupled to interface controller 105 via network.

It will be understood that the disclosure may be embodied in a computer readable non-transitory storage medium storing instructions of a computer program which when executed by a computer system results in performance of steps of the method described herein. Such storage media may include any of those mentioned in the description above.

The system and method of the present disclosure allows changing what product is to be stored and timed at a given location in the holding cabinet without a complex change involving several button presses to move into a settings or menu configuration screen which can be even more complicated and cumbersome requiring computer based applications for changing food product locations which generally require saving and uploading the new menu files back into the hot food holding cabinets. The system and method of the present disclosure allows control systems of holding cabinets to have each food product holding location programmed to accept multiple products at any point in the day, which provides flexibility to the user.

The present disclosure having been thus described with particular reference to the preferred forms thereof, it will be obvious that various changes and modifications may be made therein without departing from the spirit and scope of the present invention as defined in the appended claims.

1. A system for storing food products at heated temperatures, comprising:
a cabinet;
a storage bin in the cabinet for receiving a tray;
a temperature control device in thermal communication with the tray; and
a controller displaying via a user interface a displayed food product timer button that can be swiped to a side to change to a different food product timer button that is displayed on the user interface.

2. The system of claim 1, wherein the controller has criteria so that only similar products can be grouped in a predetermined grouping to be displayed by the displayed food product timer button and the different food product timer button.

3. The system of claim 1, wherein the different food product timer button is a plurality of different food product timer buttons, wherein the user interface is a touch screen, and wherein the touch screen can be swiped to change the displayed food product timer button or one of the plurality of different food product timer buttons displayed on the touchscreen to another of the plurality of different food product timer buttons.

4. The system of claim 1, wherein tapping contact with the displayed food product timer button activates a timer.

5. The system of claim 1, wherein the displayed food product timer button and the different food product timer button have different characteristics associated therewith selected from the group consisting of a type of alarm, a time period for a timer, a temperature to be communicated to the temperature control controller, and any combinations thereof.

6. The system of claim 1, wherein the displayed food product timer button is a plurality of displayed food product timer buttons and the different food product timer button is a plurality of different food product timer buttons, wherein the user interface displays on a touchscreen divided into a x by y matrix each of the displayed plurality of food product timer buttons in one of a plurality of sections.

7. The system of claim 6, wherein swiping contact with the touch screen in each of the plurality of sections changes each of the displayed plurality of food product timer buttons to one of the plurality of different food product timer buttons displayed in each of the plurality of sections.

8. The system of claim 7, wherein the tray is a first tray and further comprising a second tray, the storage bin is a first storage bin for receiving the first tray and further comprises a second storage bin for receiving the second tray, and the controller displaying via the user interface a first displayed food product timer button of the plurality of displayed food product timer buttons and a second displayed food product timer button of the plurality of displayed food product timer buttons, wherein the first displayed food product timer button is displayed in a first section of the plurality of sections and the second displayed food product timer button is displayed in a second section of the plurality of sections, wherein swiping contact with the first displayed food product timer button changes the first displayed food product timer button displayed in the first section to one of the plurality of different food product timer buttons that is then displayed in the first section, and wherein swiping contact with the second displayed food product timer button changes the second displayed food product timer button displayed in the second section to one of the plurality of different food product timer buttons that is then displayed in the second section.

9. The system of claim 8, wherein the first displayed food product timer button can be changed to a preselected first grouping of the plurality of different food product timer buttons, wherein the second displayed food product timer button can be changed to a preselected second grouping of the plurality of different food product timer buttons, wherein the preselected first grouping has timers for products that are receivable in the first tray, and wherein the preselected second grouping has timers for products that are receivable in the second tray.

10. The system of claim 8, wherein the first section and the second section display one of the displayed plurality of food product timer buttons or one of the plurality of different food product timer buttons that are the same, wherein tapping contact with the touch screen in the first section activates a first timer displayed in the first section on the touchscreen and tapping contact with the touch screen in the second section activates a second timer displayed in the second section on the touchscreen.

11. The system of claim 10, wherein the second timer is activated after the first timer is activated, and wherein the first section displays a first indicator indicating the first timer was activated before the second timer was activated and the second section displays a second indicator indicating the second timer was activated after the first timer was activated.

12. The system of claim 11, wherein when the first timer is deactivated, the second section displays the first indicator.

13. A method for a system for storing food products at heated temperatures, the method comprising:
providing a cabinet, a storage bin in the cabinet for receiving a tray, and a temperature control device in thermal communication with the tray;
displaying via a user interface a food product timer button that can be swiped to a side to change to a different food product timer button that is displayed on the user interface.

14. The method of claim 13, wherein the user interface has a touchscreen divided into a x by y matrix of a plurality of sections, and wherein a first section of the plurality of sections displays the food product timer button.

15. The method of claim 14, wherein the first section is selectable by a tap to activate a timer of a first product identifier.

16. The method of claim 14, further comprising determining if the first section has been tapped to activate a timer of a first product identifier.

17. The method of claim 14, further comprising determining if the first section has been swiped.

18. The method of claim 16, wherein, if the first section has been tapped to activate a timer of a first product identifier, determining if the timer of the first product identifier is the same as a second section of the plurality of sections that has a second timer that has commenced, wherein, if the second section does not have the second timer that has commenced, starting a first timer counting down from a first predetermined time for the first product identifier and displaying in the first section on the touchscreen the first timer and an indication of first out, if the second section does have the second timer that has commenced and the first product identifier is the same as the second section, the first timer is started counting down from the first predetermined time for the first product identifier displaying on the touchscreen in the first section the first timer and an indication of not first out.

19. The method of claim 18, wherein, after the first timer is started counting down from the first predetermined time for the first product identifier displaying on the touchscreen in the first section the first timer and the indication of not first out, determining if the first product identifier of the first section is the same as another of the plurality of sections and, if so, determining if the first timer for the first section has a first value that is less than a second value of a timer of any of the other of the plurality of sections having the same product identifier as the first product identifier, and if the first value is less than the second value, the first timer continues to counting down and the indication of not first out is changed to first out that is displayed in the first section.

20. The method of claim 18, further comprising determining if the first timer has counted down to zero and, if the first timer has counted down to zero, activating an alert for the first section.
